(19) United States
(12) Patent Application Publication
(10) Pub. No.: US 2019/0344683 A1
(43) Pub. Date: Nov. 14, 2019

(54) ELASTIC SENSOR SUPPORT BRACKET FOR SEAT OCCUPATION SENSORS AT THE B-SURFACE OF SEAT CUSHIONS

(71) Applicant: IEE INTERNATIONAL ELECTRONICS & ENGINEERING S.A., Echtemach (LU)

(72) Inventors: Dietmar JUNGEN, Mehren (DE); Harald SCHON, Seinsfeld (DE); Manuel WAMPACH, Junglinster (LU)

(21) Appl. No.: 16/337,599

(22) PCT Filed: Sep. 11, 2017
(86) PCT No.: PCT/EP2017/072716

§ 371 Date: Mar. 28, 2019

(30) Foreign Application Priority Data
Sep. 28, 2016 (LU) 93 239

(51) Int. Cl. B60N 2/00; B60N 2/72

(52) U.S. Cl. CPC B60N 2/002; B60R 22/48; B60N 2/72

(57) ABSTRACT

A sensor bracket for mounting a seat occupation sensor to a seat base of a seat that includes a base frame and a cushion-supporting structure connected to the base frame. The sensor bracket includes a sensor support plate having at least one plane support area for supporting the force-sensitive seat occupation sensor, at least two holder members that are configured to hold onto the cushion-supporting structure, and at least two fixation parts, wherein each fixation part supports at least one of the at least two holder members. The at least two holder members are attached to the sensor support plate via the at least two fixation parts. The at least two fixation parts and the at least two holder members are configured to enable a predetermined maximum parallel travel of the sensor support plate in at least a direction perpendicular to the plane support area.

### TECHNICAL FIELD

The invention relates to a sensor bracket for mounting at least one seat occupation sensor to a seat base of a seat, and to a seat occupation sensor unit comprising such sensor bracket.

### BACKGROUND OF THE INVENTION

Vehicle seat occupancy detection systems are nowadays widely used in vehicles, in particular in passenger cars, for providing a seat occupancy signal for various appliances, for instance for the purpose of a seat belt reminder (SBR) system or an activation control for an auxiliary restraint system (ARS), such as an airbag. Seat occupancy detection systems include seat occupancy sensors that are known to exist in a number of variants, in particular based on sensing of mechanical load or force, usually generated by a weight of a seat occupant. In order to meet requirements regarding easy integration and required robustness, force-sensitive seat occupancy sensors have typically been arranged on the B-surface of a vehicle seat, i.e. between a foam body of a seat cushion and a seat base (seat pan and/or cushion-supporting suspension springs) of the vehicle seat.

For example, German patent application publication DE 197 52 976 A1 discloses a vehicle seat occupancy sensor in the shape of a film-type pressure sensor. The pressure sensor includes a first carrier film, a spacer and a second carrier film, which are disposed on one another in the manner of a sandwich. Contact elements are arranged on the inner surfaces of the carrier films. An opening in the spacer allows the contact elements to get into contact with each other when pressure is applied on the sensor. The pressure sensor is arranged inside a cavity on the bottom side of the foam cushion of the vehicle seat. The pressure sensor is supported by a foam block, which closes the cavity and which rests on the seat pan.

Other examples of vehicle seat occupancy sensors are disclosed in patent application publications WO 2013/178485 A1; WO 2013/178487 A1; US 2007/182226 A1; WO 2011/124472 A1; and JP 2011 105277 A.

The proposed invention is initiated by the insight that tolerances of the foam body of the seat cushion and in particular of a cushion-supporting structure affect a performance of the force-sensitive seat occupancy sensors.

The auxiliary FIG. 4 schematically illustrates the effect of tolerances of a foam body FB of a seat cushion and/or tolerances of a cushion-supporting structure formed by a plurality of suspension springs SP on the sensor performance. The foam body is furnished with a cavity C that is configured to receive a spring wire of the plurality of spring wires to which a seat occupation sensor SE is attached. The figure shows the same suspension spring in different positions due to manufacturing tolerances. The seat occupation sensor is also attached to another spring wire with its right-hand portion. Depending on an actual geometry of the foam body and the suspension spring, i.e. depending on their tolerances, a left-hand portion of the seat occupation sensor may be arranged in a position that is higher or lower than an intended nominal position in which the seat occupation sensor should be. As a consequence, the seat occupation sensor is installed in a tilted position. A mechanical load that is generated by a seat occupant and transferred by the foam body to the suspension springs is applied to the seat occupation sensor at an angle with regard to an intended direction that is perpendicular to the seat occupation sensor and by that, a performance of the seat occupation sensor is changed in an uncontrolled way.

### SUMMARY

It is therefore an object of the invention to provide a seat occupation sensor unit, in particular a vehicle seat occupation sensor unit, whose performance is robust and insusceptible towards mechanical tolerances of the seat cushion and/or a cushion-supporting structure.

In one aspect of the present invention, the object is achieved by a sensor bracket for mounting at least one seat occupation sensor to a seat base of a seat, in particular a vehicle seat, that comprises a base frame and a cushion-supporting structure connected to the base frame. The sensor bracket includes:
a sensor support plate comprising at least one plane support area that is configured for supporting at least one force-sensitive seat occupation sensor,
at least two holder members that are configured to hold onto the cushion-supporting structure, and
at least two fixation parts, wherein each fixation part is configured to support at least one of the at least two holder members.

The at least two holder members are attached to the sensor support plate via the at least two fixation parts. The at least two fixation parts and the at least two holder members form displacement means that are configured to enable a predetermined maximum parallel travel of the sensor support plate in at least a direction perpendicular to the plane support area.

The phrase “configured to”, as used in this application, shall in particular be understood as being specifically programmed, laid out, furnished or arranged. The term “vehicle”, as used in this application, shall particularly be understood to encompass passenger cars, trucks and buses.

According to at least some embodiments of the invention, a sensor bracket for a seat occupation sensor can be provided with a floating fixation. Within the limits of the predetermined maximum parallel travel, a tilted position of the seat occupation sensor can be avoided irrespective of mechanical tolerances of a seat cushion and/or a cushion-supporting structure, by which an actual position, in the intended orientation, of the seat occupation sensor in at least the direction perpendicular to the plane support area is determined.

The proposed sensor bracket may be especially advantageous in the case of the cushion-supporting structure being formed by a plurality of suspension springs, but may as well be beneficially applied in case of other cushion-supporting structures.

In one embodiment of the sensor bracket, at least the sensor support plate and the at least two fixation parts are made from a plastic material, in particular a thermoplastic material. In this way, an especially simple and easy-to-install solution for the at least two fixation parts that mechanically attach the at least two holder members to the sensor support plate is provided.

In some preferred embodiments, the sensor bracket comprises at least three holder members that are configured to hold onto the cushion-supporting structure, wherein one of the at least two fixation parts has an elongated shape, such as a rectangular shape or a trapezoidal shape or an oval shape, and is attached to the sensor support plate with one of its longer sides, and wherein at least two holder members of the at least three holder members are arranged at an opposing side of the elongated-shaped fixation part in a spaced manner.

In this way, the sensor bracket can be firmly attached to the cushion-supporting structure, and a predetermined maximum parallel travel of the sensor support plate can readily be enabled.

Preferably, a largest bending stiffness of the at least two fixation parts with regard to an external force acting in the direction perpendicular to the plane support area is a fraction of a bending stiffness of the sensor support plate in the same direction. The term “fraction”, as used in this application, shall particularly be understood as a fractional amount of less than 20%, more preferable of less than 10% and, most preferably, of less than 5%.

In this way, a force or torque that is applied to the sensor support plate due to tolerances of a seat cushion or a cushion-supporting structure can mainly result in a deflection of the at least two fixation parts. In a suitable embodiment, a sensor bracket can be provided wherein a predetermined maximum parallel travel of the sensor support plate in the direction perpendicular to the plane support area can be enabled by bending the at least two fixation parts without tilting the sensor support plate.

In some preferred embodiments of the sensor bracket, at least one of the at least two holder members is formed as a clip holder. In this way, an easy installation of the sensor bracket is enabled. Further, the predetermined maximum parallel travel of the sensor support plate in the direction perpendicular to the plane support area can be facilitated by allowing the clip holder to rotate about a member of the cushion-supporting structure. For example, the clip holder may be allowed to rotate about a wire of a suspension spring of the plurality of suspension springs forming the cushion-supporting structure.

In some preferred embodiments of the sensor bracket, the at least one of the at least two holder members includes a linear slide bearing for guiding a travel of the holder member at the cushion-supporting structure in the direction perpendicular to the plane support area. In this way, the predetermined maximum parallel travel of the sensor support plate in the direction perpendicular to the plane support area can be facilitated by allowing the holder member to shift along a member of the cushion-supporting structure in this direction.

Preferably, the at least one of the at least two holder members is held at the cushion-supporting structure by a friction fit. The friction between the holder member and the cushion-supporting structure is laid out to allow the holder member to slide along the linear slide bearing and to retain the holder member at the cushion-supporting structure during sensor operation.

In preferred embodiments of the sensor bracket, the at least two fixation parts are arranged at opposite sides of the sensor support plate. Each of the two fixation parts has a corrugated profile to provide resilience in the direction perpendicular to the plane support area and also in a direction that is arranged in parallel to the plane support area and perpendicular to the corrugations.

In this way, a predetermined maximum parallel travel of the sensor support plate can be enabled in the direction perpendicular to the plane support area as well as in the direction arranged in parallel to the plane support area without tilting the sensor support plate by deflecting the at least two fixation parts in one of the directions or in both.

The corrugated profile may be a circular wave profile, but other profiles such as a triangular wave profile or a square wave profile are also contemplated.

Preferably, the two fixation parts are made from a foil of an elastic metal or from a plastic material, in particular thermoplastic material, and are shaped as a sheet.

If at least the sensor support plate and at least one of the at least two fixation parts are made from a plastic material, in particular a thermoplastic material, and are integrally formed, an especially part and cost-saving way of manufacturing can be applied, and low manufacturing tolerances and highly-reproducible mechanical properties, in particular for the at least one of the at least two fixation parts, can be accomplished.

In another aspect of the invention, a seat occupation sensor unit is provided. The seat occupation sensor unit comprises an embodiment of the sensor bracket disclosed herein, and at least one force-sensitive seat occupation sensor that is attached to and supported by the at least one plane support area.

The benefits presented in context with the various embodiments of the sensor bracket apply to the seat occupation sensor unit to the full extent.

### BRIEF DESCRIPTION OF THE DRAWINGS

Further details and advantages of the present invention will be apparent from the following detailed description of not limiting embodiments with reference to the attached drawing, wherein:

FIG. 1 shows a schematic perspective view from above of a seat occupation sensor unit comprising a first embodiment of the sensor bracket in accordance withthe invention and details of the sensor bracket in a front view,

FIG. 2 illustrates a second embodiment of the sensor bracket in accordance with the invention in a perspective view from above and a detail of the sensor bracket in a front view,

FIG. 3 illustrates a third embodiment of the sensor bracket in accordance with the invention in a perspective view from above and a detail of the sensor bracket in a front view, and

FIG. 4 illustrates the effect of tolerances of a foam body of a seat cushion and/or tolerances of a cushion-supporting structure formed by a plurality of suspension springs on the sensor performance.

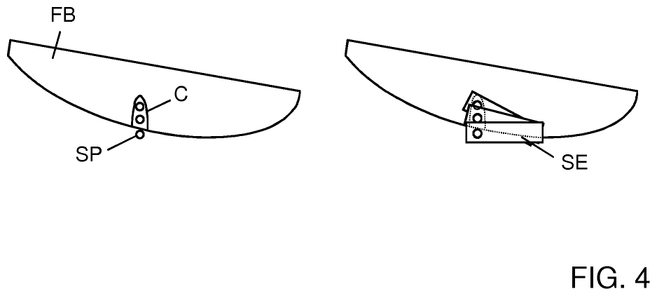

### DESCRIPTION OF THE ILLUSTRATED EMBODIMENTS

In the following, embodiments of a sensor bracket in accordance with the invention are disclosed. The individual embodiments are identified by a prefix cipher of the particular embodiment. Features whose function is the same or basically the same in all embodiments are identified by reference numbers made up of the prefix cipher of the embodiment to which it relates, followed by the numeral of the feature.

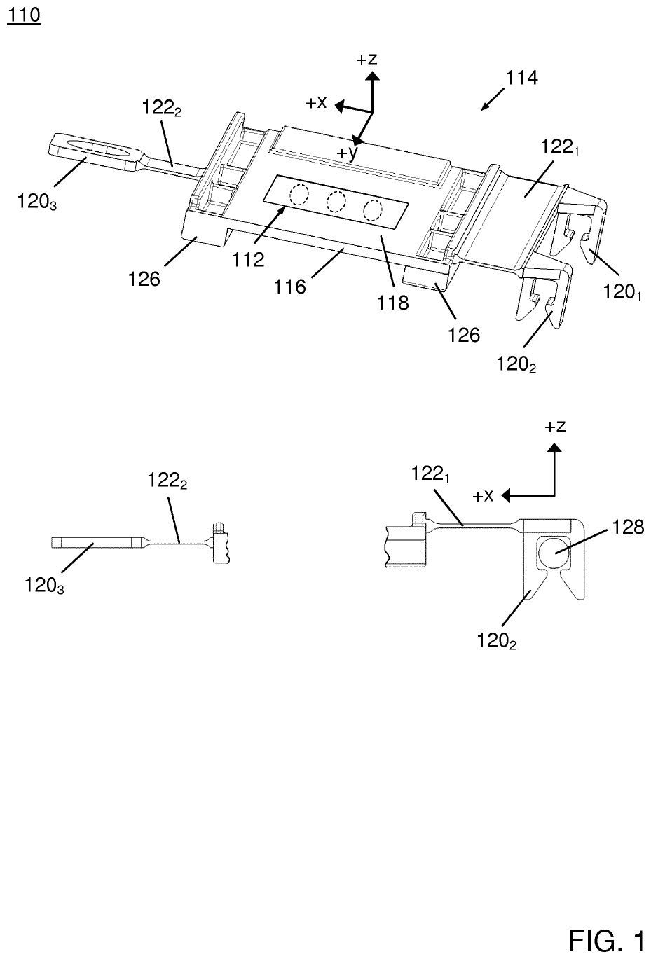

FIG. 1 shows a schematic perspective view from above (upper part of FIG. 1) of a seat occupation sensor unit 110 comprising a first embodiment of the sensor bracket 114 in accordance with the invention and details of the sensor bracket 114 in a front view (lower part of FIG. 1).

The sensor bracket 114 is intended for mounting a seat occupation sensor 112 of the seat occupation sensor unit 110, wherein the seat occupation sensor 112 is to be arranged on a B-surface of a vehicle seat between a foam body of a seat cushion and a vehicle seat base. The vehicle seat base comprises a base frame and a seat cushion-supporting structure designed as a plurality of cushion-supporting suspension springs 128.

The sensor bracket 114 includes a sensor support plate 116 of a substantially rectangular shape that comprises a plane support area 118 on a top surface. The plane support area 118 is configured for supporting the force-sensitive seat occupation sensor 112. The sensor bracket 114 and the seat occupation sensor 112, in a state of being attached to and supported by the plane support area 118, form the seat occupation sensor unit 110.

The force-sensitive seat occupation sensor 112 is designed as a foil-type switching member that is well known in the art. The force-sensitive seat occupation sensor 112 is configured to change a switching state in a reversible manner if a mechanical load, usually generated by the weight of a seat occupant, corresponding to at least a predetermined threshold value is applied to the force-sensitive seat occupation sensor 112 in a direction that is perpendicular to the plane support area 118. In this application, this direction is referred to as the z-direction, with the positive z-direction pointing upwards. Further, a Cartesian coordinate system is used with the x-direction pointing towards the left-hand side of FIG. 1 and the y-direction pointing towards the viewer of FIG. 1.

It should be noted that while FIG. 1 shows the force-sensitive seat occupation sensor 112 extending in x-direction in the used coordinate system, the force-sensitive seat occupation sensor 112 could as well be mounted to extend in y-direction. Furthermore it will be appreciated, that the sensor bracket 114 may be mounted to the seat cushion-supporting structure such that the shown x-direction corresponds to the driving direction of the vehicle or as well such that the shown y-direction corresponds to the driving direction of the vehicle.

For increasing a bending stiffness of the plane support area 118, the sensor support plate 116 includes two shoulder members 126 arranged at a bottom surface and running along two opposing sides of the sensor support plate 116.

The sensor bracket 114 further comprises three holder members 120₁, 120₂, 120₃ that are configured to hold onto the cushion-supporting structure. A first and a second holder member 120₁, 120₂ of the three holder members 120₁, 120₂, 120₃ are formed as plastic clip holders for an easy and quick installation at a spring wire with circular cross-section of the suspension spring 128. The third holder member 120₃ is designed as an elongated eyelet that is configured to receive a fixation clip for attaching the third holder member 120₃ to the seat cushion-supporting structure.

It is noted herewith that the terms “first”, “second”, etc. are used in this application for distinction purposes only, and are not meant to indicate or anticipate a sequence or a priority in any way.

Furthermore, the sensor bracket 114 includes two fixation parts 122₁, 122₂. The first fixation part 122₁ is configured to support the first 120₁ and the second holder member 120₂. The second fixation part 122₂ is configured to support the third holder member 120₃.

The first fixation part 122₁ has a rectangular shape and is attached to the sensor support plate 116 with one of its long sides. The first 120₁ and the second holder member 120₂ are arranged at an opposing side of the rectangular-shaped first fixation part 122₁ in a spaced manner.

The first 120₁ and the second holder member 120₂ are attached to the sensor support plate 116 via the first fixation part 122₁. The third holder member 120₃ is attached to the sensor support plate 116 via the second fixation part 122₂.

The sensor support plate 116 and the two fixation parts 122₁, 122₂ are made from a thermoplastic material, e.g. polybutylene terephthalate (PBT), polyamide (PA), acrylonitrile butadiene styrene (ABS), polyethylene terephthalate (PET), polyoxymethylene (POM) or any other suitable material, and are integrally formed by using an injection molding process. Fillets are used at the joints in order to prevent notch effect and stress concentration, as is known in the art.

In comparison to a bending stiffness of the sensor support plate 116 with regard to an external mechanical force applied parallel to the z-direction, a largest bending stiffness of the two fixation parts 122₁, 122₂ in the same direction is only a fraction of less than 5%. In other words, for mechanical forces applied parallel to the z-direction the sensor support plate 116 can be considered rigid compared to the fixation parts 122₁, 122₂.

In the process of mounting the sensor bracket 114 to the suspension spring 128, the actual geometry of the foam body and the suspension springs, if differing from a nominal geometry due to manufacturing tolerances, generates mechanical forces that act onto the sensor bracket 114. Due to the greatly differing bending stiffness, the two fixation parts 122₁, 122₂ and the holder members 120₁, 120₂, 120₃ will be deflected by these generated mechanical forces, the first 120₁ and the second holder member 120₂ will be rotated about the wire of the suspension spring 128 and the sensor support plate 116 will be shifted parallel along the z-direction virtually unbent and untwisted. The rotation of the first 120₁ and the second holder member 120₂ makes a travel of the sensor support plate 116 in the x-direction necessary. The elongated eyelet provides the freedom for the required travel of the sensor support plate 116.

By that, a mechanical preload on the plane support area 118 and a tilting of the plane support area 118 by installing the sensor bracket 114 is prevented. The two fixation parts 122₁, 122₂ and the holder members 120₁, 120₂, 120₃ form displacement means that enable a predetermined maximum parallel travel of the sensor support plate 116 parallel to the z-direction. The maximum parallel travel is determined by the maximum deflection of the two fixation parts 122₁, 122₂.

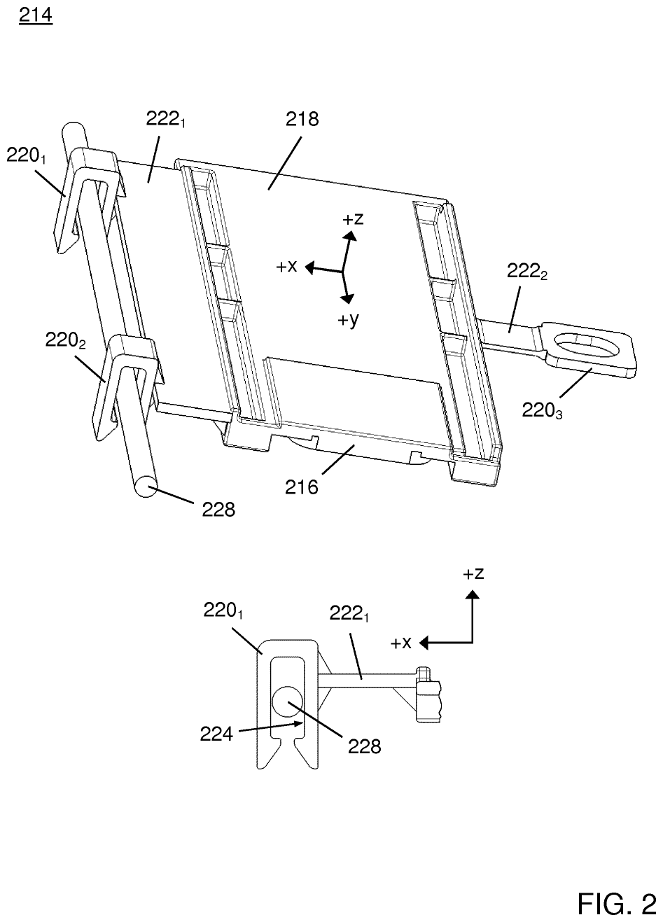

FIG. 2 illustrates a second embodiment of the sensor bracket 214 in accordance with the invention in a perspective view from above and a detail of the sensor bracket 214 in a front view. In order to avoid repetition, only those features that differ from the first embodiment will be described. As for features that are common to both embodiments, reference is made to the description of the first embodiment.

The sensor bracket 214 includes a sensor support plate 216 of a substantially rectangular shape that comprises a plane support area 218 on a top surface. Like the sensor bracket 114 of the first embodiment, the second embodiment of the sensor bracket 214 comprises three holder members 220₁, 220₂, 220₃ that are configured to hold onto the cushion-supporting structure. A first 220₁ and a second holder member 220₁ of the three holder members 220₁, 220₂, 220₃ are formed as plastic clip holders for an easy and quick installation at a spring wire of a suspension spring 228 with circular cross-section. As in the first embodiment, the third holder member 220₃ is designed as an elongated eyelet that is configured to receive a fixation clip for attaching the third holder member 220₃ to the seat cushion-supporting structure. Also, a second fixation part 222₂ that forms part of the sensor bracket 214 is identical to the one 122₂ in the first embodiment.

The main differences to the sensor bracket 114 of the first embodiment is that the first holder member 220₁ and the second holder member 220₂ each include a linear slide bearing 224 for guiding a travel of the holder member 220₁, 220₂ at a spring wire of a suspension spring 228 in the direction perpendicular to the plane support area 218, i.e. the z-direction.

In the process of mounting the sensor bracket 214 to the suspension springs 228, mechanical forces may act onto the sensor bracket 214 due to manufacturing tolerances of the foam body and the suspension springs 228. The linear slide bearing 224 allows the sensor support plate 216 to be shifted parallel along the z-direction virtually unbent and untwisted. The two fixation parts 222₁, 222₂ and the first 220₁ and the second holder member 220₂ form displacement means that provide the predetermined maximum parallel travel of the sensor support plate 216 in the z-direction. The elongated eyelet provides the freedom for the required travel of the sensor support plate 216 in the x-direction.

It is noted that in this second embodiment, a bending stiffness of the first fixation part 222₁ with regard to an external force acting in the z-direction does not necessarily have to be a fraction of a bending stiffness of the sensor support plate 216 in the same direction.

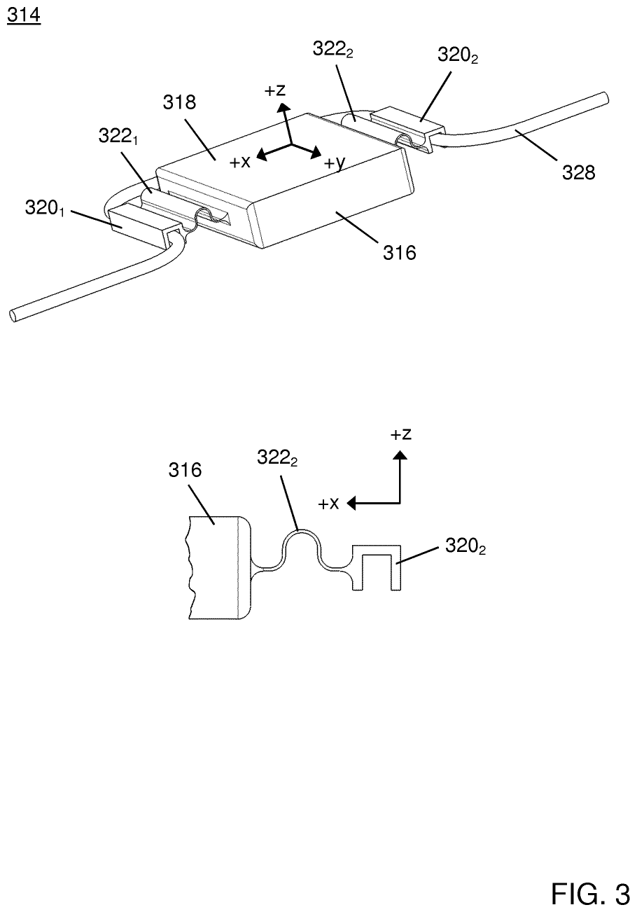

FIG. 3 illustrates a third embodiment of the sensor bracket 314 in accordance with the invention in a perspective view from above and a detail of the sensor bracket 314 in a front view. Again, only those features that differ from the first embodiment and the second embodiment will be described. As for features that are common to both embodiments, reference is made to the description of the first embodiment.

The sensor bracket 314 comprises two U-profile metal holder members 320₁, 320₂ that are fixedly clamped onto a spring wire of a suspension spring 328 with circular cross-section forming part of the cushion-supporting structure.

Further, the sensor bracket 314 includes two fixation parts 322₁, 322₂ which are rectangular-shaped in a top view. In this specific embodiment, the first fixation part 322₁ and the second fixation part 322₂ are made of a thin, elastic metal foil, are identically designed and have a corrugated profile in the x-direction, formed by a circular wave profile. In other embodiments, the first fixation part and the second fixation part may be made of a thermoplastic material, for instance polybutylene terephthalate (PBT), polyamide (PA), acrylonitrile butadiene styrene (ABS), polyethylene terephthalate (PET), polyoxymethylene (POM) or any other suitable material. The first fixation part 322₁ is configured to support the first holder member 320₁ at a straight side that runs perpendicular to the wave profile, i.e. parallel to the y-direction. The second fixation part 322₂ is configured to support the second holder member 320₂ at a straight side in an identical manner.

Each one of first fixation part 322₁ and the second fixation part 322₂ is attached to the sensor support plate 316 with a side that runs parallel to the y-direction and is remote to the respective holder member 320₁, 320₂. The first fixation part 322₁ and the second fixation part 322₂ are arranged at opposing sides, with regard to the x-direction, of the rectangular-shaped sensor support plate 316.

In a process of mounting the sensor bracket 314 to the suspension springs 328, the actual geometry of the foam body and the suspension springs 328, if differing from a nominal geometry due to manufacturing tolerances, generates mechanical forces that act onto the sensor bracket 314. The corrugated profiles of the two fixation parts 322₁, 322₂ provide resilience both parallel to the x-direction and parallel to the z-direction, which allows to fixedly clamp the two U-profile metal holder members 320₁, 320₂ onto the spring wire of the suspension spring 328.

By that, a mechanical preload of the plane support area 318 and a tilting of the plane support area 318 by installing the sensor bracket 314 is prevented. The two fixation parts 322₁, 322₂ and the holder members 320₁, 320₂ form displacement means that enable a predetermined maximum parallel travel of the sensor support plate 316 along both the x-direction and the z-direction. The maximum parallel travel is determined by the maximum deflection of the two corrugated fixation parts 322₁, 322₂.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. A sensor bracket for mounting at least one seat occupation sensor to a seat base of a seat that comprises a base frame and a cushion-supporting structure connected to the base frame, the sensor bracket including:
a sensor support plate comprising a top surface, a bottom surface, and at least one plane support area on the top surface, said at least one plane support area being configured for supporting at least one force-sensitive seat occupation sensor,
at least two holder members that are configured to hold onto the cushion-supporting structure, and
at least two fixation parts, each fixation part being configured to support at least one of the at least two holder members,
wherein the at least two holder members are attached to the sensor support plate via the at least two fixation parts, and
wherein the at least two fixation parts and the at least two holder members are configured to enable a predetermined maximum parallel travel of the sensor support plate in at least a direction perpendicular to the plane support area.

2. The sensor bracket as claimed in claim 1, wherein at least the sensor support plate and the at least two fixation parts are made from a plastic material.

3. The sensor bracket as claimed in claim 1, comprising at least three holder members that are configured to hold onto the cushion-supporting structure, wherein one of the at least two fixation parts has an elongated shape and is attached to the sensor support plate with one of its sides, and wherein at least two holder members of the at least three holder members are arranged at an opposing side of the elongated-shaped fixation part in a spaced manner.

4. The sensor bracket as claimed in claim 1, wherein a largest bending stiffness of the at least two fixation parts with regard to an external force acting in the direction perpendicular to the plane support area is a fraction of a bending stiffness of the sensor support plate in the same direction.

5. The sensor bracket as claimed in claim 1, wherein at least one of the at least two holder members is formed as a clip holder.

6. The sensor bracket as claimed in claim 5, wherein the at least one of the at least two holder members includes a linear slide bearing for guiding a travel of the holder member at the cushion-supporting structure in the direction perpendicular to the plane support area.

7. The sensor bracket as claimed in claim 1, wherein the at least two fixation parts are arranged at opposite sides of the sensor support plate, and wherein each of the two fixation parts has a corrugated profile to provide resilience in the direction perpendicular to the plane support area and also in a direction that is arranged in parallel to the plane support area and perpendicular to the corrugations.

8. The sensor bracket as claimed in claim 7, wherein the two fixation parts that are arranged at opposite sides of the sensor support plate are made from a foil of an elastic metal or are made of a sheet plastic material.

9. The sensor bracket as claimed in claim 1, wherein at least the sensor support plate and at least one of the at least two fixation parts are made from a plastic material and are integrally formed.

10. A seat occupation sensor unit, comprising
a sensor bracket as claimed in claim 1, and
at least one force-sensitive seat occupation sensor that is attached to and supported by the at least one plane support area.
